(19) United States
(12) Patent Application Publication
(10) Pub. No.: US 2007/0000831 A1
(43) Pub. Date: Jan. 4, 2007

(54) Controlled release of additives in cooling systems

(75) Inventors: Dennis Kelly, Chicago, IL (US); Joseph C. Drozd, Park Ridge, IL (US); Thomas Blakemore, Flossmoor, IL (US); Doug Hudgens, Cookeville, TN (US); Harold R. Martin, Cookeville, TN (US)

Correspondence Address: STOUT, UXA, BUYAN & MULLINS LLP, 4 VENTURE, SUITE 300, IRVINE, CA, 92618, US

(73) Assignees: Fleetguard, Inc., Nashville, TN (US); Dober Chemical Corporation, Midlothian, IL (US)

(21) Appl. No.: 11/516,150

(22) Filed: Sep. 5, 2006

Related U.S. Application Data
(63) Continuation of application No. 10/701,133, filed on Nov. 3, 2003.
Application No. 10/701,133 is a division of application No. 09/939,214, filed on Aug. 24, 2001, now abandoned.

(51) Int. Cl. B01D 63/00

(52) U.S. Cl. 210/321.6; 210/696; 210/749

(57) ABSTRACT

A container for releasing a chemical additive into a coolant composition comprises a coolant-impermeable casing having a hollow interior and an additive composition comprising at least one coolant soluble additive. The additive is held within the container by at least one coolant-permeable element provided at or near an opening in the casing and is effective to provide for release of additive(s) into the coolant composition. Methods of releasing additives into coolant compositions are also provided.

### CROSS-REFERENCE OF RELATED APPLICATIONS

The present application is a continuation of U.S. application Ser. No. 10/701,133, filed Nov. 3, 2003 which is a divisional of U.S. application Ser. No. 09/939,214 filed Aug. 24, 2001, the disclosures of each of these applications being incorporated in their entirety herein by this specific reference.

### FIELD OF THE INVENTION

The present invention relates to devices and methods for providing chemical additives to the coolant fluid in cooling systems, for example, but not limited to, such systems in internal combustion engines, such as those in automobiles, trucks, heavy equipment, and the like, open circulating cooling or coolant systems, such as cooling towers, and the like.

### BACKGROUND OF THE INVENTION

Vehicle cooling systems are plagued by the buildup of scale and/or corrosion often due to thermal breakdown of dissolved components and assault of dissolved electrolytes on metal surfaces of the cooling system. In an effort to mitigate this damage, various chemical additives typically are added periodically to the cooling system, e.g., whenever coolant levels are topped up following evaporation. The chemical additives include, but are not limited to, anti-foulants, anti-scaling agents, corrosion inhibitors, pH buffering agents, microbicides, and the like. Usually, the concentration of a particular agent in the cooling system, which can vary due to evaporation, chemical neutralization, and degradation, etc., is not known at any given time. Instead, a predefined amount of additives in a predetermined ratio is added to the system at regular maintenance intervals or whenever coolant levels drop to a level requiring additional coolant.

Various methods of introducing additives to vehicle fluid systems, generally, have been proposed. Rohde U.S. Pat. No. 3,749,247 describes a container for releasing an oxidation inhibitor into hydrocarbon-based lubricating oil in a working engine. The oxidation inhibitor is held in a polyolefin container that permits the additive to permeate through the container wall into the oil. A further approach is described by Lefebvre U.S. Pat. No. 5,591,330, which discloses a hydrocarbon oil filter wherein oxidation additives in a thermoplastic material are mounted in a casing between a particle filtering material and a felt pad. Reportedly, the thermoplastic material dissolves in the presence of high temperature oil thereby releasing the additives. Additionally, an additive release device for use in an engine hydrocarbon fuel line is proposed by Thunker et al U.S. Pat. No. 5,456,217. The latter device comprises a partially permeable cartridge positioned in the filling neck of the fuel tank so that whenever fuel is added a portion of the additive contents of the cartridge is released into the tank.

Aqueous-based coolants present an environment distinct from those of hydrocarbon fluids. For instance, most thermoplastics do not dissolve in aqueous solutions. Moreover, relatively large quantities of additives, e.g., 0.5 lbs., need to be provided in a typical aqueous coolant. Sudden provision of such large amounts of additives can cause a “slug” of material to precipitate and circulate in the system, which can result in damage and failure of pump seals. Accordingly, Hudgens et al U.S. Pat. No. 5,662,799 propose an elaborate coolant filter that filters the coolant and releases an amount of additive through a diffusion tube, or alternatively through a diffusion wafer, into the coolant. Alternative versions of this approach are proposed by Tregidgo et al U.S. Pat. No. 5,435,346 and Cheadle et al U.S. Pat. No. 4,782,891, which utilize the corrosive nature of the coolant to erode a separating means, such as a rod, in the coolant filter and release anti-corrosive material.

It would be advantageous to provide relatively low cost, quickly installed apparatus and methods that release chemical additives into the coolant of a cooling system at a sustained rate without allowing the coolant to become corrosive or otherwise significantly detrimentally affecting the coolant or the cooling system.

### SUMMARY OF THE INVENTION

New apparatus and methods for providing release, preferably sustained release, of at least one additive into the coolant composition of a cooling system have been discovered. The present apparatus and methods effectively provide for gradual, preferably sustained, and more preferably substantially controlled, release of additive from the apparatus into a coolant composition, for example, a liquid, such as substantially an aqueous liquid; a liquid comprising water and at least one freezing point depressant, such as at least one glycol; substantially a non-aqueous liquid; and the like. Because the additive is released only through a portion of the apparatus, it has been found relatively convenient to substantially control the release rate of the additive.

Many components of the apparatus of the invention, other than the additive or additives, are substantially insoluble in a coolant composition, even at the elevated temperatures of such composition in a working environment, e.g., an engine cooling system, so that these components remain intact and do not dissolve into and/or otherwise detrimentally affect the coolant and cooling system. In addition, the insoluble components of the present apparatus can be reused after release of the coolant additive contained therein. The present apparatus are easy and straightforward to manufacture cost effectively and can easily and effectively be used in cooling systems with little or no modification.

In one broad aspect, the present invention is directed to chemical additive containers for use in cooling systems, for example, those associated with engines, cooling towers and the like, which are designed to provide gradual, preferably sustained, and more preferably substantially controlled, release of at least one additive(s) into a coolant. Exemplary coolant compositions are substantially aqueous liquids; liquids including water and at least one freezing point depressant, e.g., at least one glycol, such as ethylene glycol, propylene glycol and the like glycols; substantially non-aqueous liquids, e.g., coolants based substantially on one or more glycols (for example, containing at least about 50% by weight of one or more glycols); and the like.

The present containers comprise a coolant-impermeable casing defining a substantially hollow interior and at least one opening. A coolant additive composition comprising at least one chemical additive soluble in coolant, for example, at least one coolant-soluble supplemental additive, is provided in the interior of the casing. The coolant additive may be provided in the form of a liquid, gel, paste, or in solid form. In one particularly useful embodiment of the invention, the coolant additive composition is provided as a plurality of particles, or in particulate form, for example, in the form of beads, tablets, pellets, grains or other particulate form.

The casing and other coolant-impermeable components of the apparatus of the present invention are preferably composed of materials selected from suitable metals, coolant-insoluble polymeric materials, combinations thereof and mixtures thereof. Useful casings can be made of materials selected from metals, such as steel, aluminum, metal alloys and the like, polyvinyl chloride, polyethylene, polypropylene, nylon, polyethylene vinyl acetate (EVA), polypropylene vinyl acetate (PVA), combinations thereof and mixtures thereof, and the like.

The containers of the present invention also include at least one coolant-permeable element or component which is provided at or near the at least one opening of the casing. This coolant-permeable element is effective to provide for release of a portion of the chemical additive composition in the casing into a coolant composition, for example, a liquid coolant composition in contact with the casing. Such release occurs over a period of time so that a portion of the chemical additive is retained within the casing, at least after the initial release of additive occurs. The additive release obtained in accordance with the present invention preferably is sustained additive release.

In one embodiment of the invention, the casing is substantially cylindrical in shape. The casing includes at least one opening, for example, at an end of the casing or in a side wall of the casing, where coolant is allowed to contact a portion of the coolant additive composition contained within the casing. For example, an end cap can be employed which cradles or attaches to the open end and retains the coolant additive composition within the casing. In one embodiment of the invention, the cylindrical shaped casing includes two open ends, each open end being covered by an end cap. The end cap preferably comprises a coolant-impermeable material and is effective to retain the coolant additive composition within the casing. The end cap includes one or more inlets or openings for allowing fluid communication between coolant composition located exterior to the casing and the coolant additive composition within the casing to permit the release, for example, by diffusion or otherwise, of the chemical additive into the coolant composition, preferably at a substantially controlled rate.

In another embodiment, the casing is substantially bowl-shaped in form. The at least one opening may be located at any point of the casing, for example, on the top of the casing, in a side (side wall) of the casing and/or in the bottom of the casing. In one useful embodiment, particularly when the bowl-shaped casing has an open end, for example, an open top end, a cap member may be included which provides means for retaining the coolant additive composition within the casing interior. The cap member advantageously is made of polymeric material and includes at least one inlet or opening, and preferably a plurality of inlets or openings, for allowing contact between the coolant additive composition and the coolant composition. The cap member may be secured to an interior surface of the casing, and may be somewhat recessed therein. In one embodiment of the invention, the cap member is removably secured or removably sealed to the casing, for example, by means of an o-ring or other suitable, e.g., conventional, sealing element or assembly. In addition, a plate member may be provided and fixed within the bowl-shaped casing. The plate member includes one or more plate inlets which substantially align with the cap member inlets. The plate member may be made of any suitable coolant-insoluble material.

In one embodiment, the container of the present invention comprises the bowl-shaped casing having both the cap member and the plate member disposed across the container open end. A coolant-permeable element is disposed, or sandwiched, between the cap member and the plate member.

The coolant-permeable element(s) or component(s) may comprise any suitable coolant-permeable structure, and all such structures are included within the scope of the present invention. In one particularly useful embodiment, the coolant-permeable element or component comprises a filter member or filter media, for example, a porous or semi-permeable membrane.

The porous or semi-permeable membrane of the apparatus of the invention may be made of any suitable material that permits the desired, preferably sustained, release of chemical additive into the coolant, particularly when the casing is in contact with coolant. The membrane can be made of a coolant-insoluble material, for instance, having irregularly-sized channels or discrete-sized pores therein. As used herein, a “porous” membrane refers generally to membranes having pores in a substantially discrete size range, such as a wire screen or filter media, for example, filter paper and the like. As used herein, a “semi permeable” membrane refers to a continuous medium, which does not have pores in a discrete size range, but instead preferably permits diffusion of molecules through narrow channels, the size of which can be difficult to measure.

In one embodiment, the membrane, for example, the porous or semi-permeable membrane, comprises one or more metals and/or glasses and/or one or more polymeric materials and/or one or more papers and/or the like, combinations thereof and mixtures thereof. Very useful membranes can be made of materials selected from nylon, cellulose acetate, cellulosic polymers, glasses, polyester, polyurethane, polyvinyl chloride, polyethylene vinyl acetate, polypropylene vinyl acetate, natural and synthetic rubbers, and the like, combinations thereof and mixtures thereof.

Alternatively or additionally, the coolant-permeable element(s) or component(s) can include a coolant-soluble material, such as in the form of a dissolvable, that is, coolant-dissolvable, seal, which dissolves, for example, gradually, in the presence of the coolant to effect release of the additive from the casing. The dissolvable seal may comprise, for example, a coolant-soluble polymer seal. Preferably, although not necessarily, the at least one coolant-permeable element includes a support structure, for example, a wire screen or cloth, for example, woven cloth, or other coolant-insoluble material or combinations thereof, which may be coated with a coolant-soluble polymer to form a suitable seal structure. Alternatively, the dissolvable seal may comprise the coolant soluble polymer alone, without such a support structure. It is also noted that the membrane can be coated, e.g., with a polymeric material, such as a coolant-soluble polymeric material or a coolant-insoluble material, in order to more effectively control release of additive from the container into the coolant.

In another broad aspect, the invention is directed to methods for releasing a chemical additive, preferably at a sustained, more preferably substantially controlled, rate into a coolant composition, for example, a liquid coolant. Optionally, the liquid coolant can contain additives other than those being released by the apparatus of the present invention. The present methods comprise placing a container as set forth herein in contact with a coolant composition. When the container is exposed to a coolant composition, the coolant passes through, for example, diffuses through, the coolant-permeable element or elements and contacts a portion of the coolant additive composition. Release, preferably sustained, substantially controlled release, of additive or additives into the coolant composition is obtained, for example, by diffusion through the coolant-permeable element.

In one useful embodiment, the container in accordance with the present invention at least partially replaces and/or is integrated into the center tube of a filter assembly used to filter coolant, for example, while the coolant is being used. Thus, the container is effective to provide additive release and as a structural member in a filter assembly.

Commonly assigned U.S. patent application Ser. No. (Attorney Docket No. D-2979), filed on even date herewith, is directed to somewhat related subject matter. The disclosure of this co-pending U.S. application is incorporated in its entirety herein by reference.

Each and every feature described herein, and each and every combination of two or more of such features, is included within the scope of the present invention provided that the features included in such a combination are not mutually inconsistent.

Additional aspects and advantages of the present invention are set forth in the following description and claims, particularly when considered in conjunction with the accompanying drawings in which like parts bear like reference numerals.

### BRIEF DESCRIPTION OF THE DRAWINGS

FIG. 1A is a partial cross-sectional view of a preferred cylindrical additive container wherein additive is released through both ends of the container in accordance with the present invention. In this embodiment, screw caps at either end of the container are provided with holes or openings.

FIG. 1B is an exploded view of various components of the coolant-permeable element used in the container shown in FIG. 1A.

FIG. 2A is a cross-sectional view of an alternate cylindrical shaped additive container of the present invention, wherein a press-fit end cap is provided with an orifice that serves to control release of additive from the container.

FIG. 2B is an end view of the end cap shown in FIG. 2A.

FIG. 3A is a schematic illustration showing the additive container of FIG. 1A in use in conjunction with a coolant line.

FIG. 3B is a schematic illustration showing the additive container of FIG. 2A in use in conjunction with a coolant system.

FIG. 4A is a cross-sectional view of an additional embodiment of an additive container in accordance with the present invention.

FIG. 4B is a view taken generally along the line of 4B-4B of FIG. 4A.

FIG. 5A is a cross-sectional view of another embodiment of an additive container in accordance with the present invention.

FIG. 5B is a view taken generally along the line of 5B-5B of FIG. 5A.

FIG. 6 is a schematic illustration of a further embodiment of a generally bowl-shaped additive container in accordance with the present invention.

FIG. 7 is a schematic illustration of still another embodiment of a generally cylindrical shaped additive container in accordance with the present invention.

FIG. 8 is a schematic illustration of a coolant filter assembly including an additive container.

### DETAILED DESCRIPTION OF THE INVENTION

The present invention is directed to containers for use in coolant or cooling systems, including, but not limited to, such systems in or associated with motors, engines, such as internal combustion engines, e.g., in vehicles such as automobiles, planes, trains, trucks and the like, in heavy equipment, including both stationary and mobile equipment, as well as open circulating coolant or cooling systems, such as cooling towers and the like. Such containers are effective in gradually, over a prolonged period of time, releasing, for example, under sustained conditions, one or more chemical additives into coolant, preferably a liquid coolant. Representative coolant compositions include, but are not limited to, liquids, such as substantially an aqueous liquid; a liquid comprising water and at least one freezing point depressant, such as at least one glycol; substantially a non-aqueous liquid; and the like.

Such coolant compositions often initially (that is prior to treatment in accordance with the present invention) include one or more glycols and/or other freezing point depressants and/or other additives that provide one or more benefits to the coolant composition and/or cooling system. In any event, the presence of a substantial amount, preferably a major amount, that is, at least about 50% by weight, of water or a glycol in such coolant compositions renders them substantially different chemically from hydrocarbon-based lubricating oils and hydrocarbon fuels. Optionally, these coolants can contain additives other than those being released by the apparatus of the present invention. These additives include, but are not limited to, such additive or additives as which is (are) conventionally used in the type of coolant in question.

Unless otherwise expressly noted to the contrary, each of the words “include”, “includes”, “included” and “including,” and the phrase “for example” and abbreviation “e.g.” as used herein in referring to one or more things or actions means that the reference is not limited to the one or more things or actions specifically referred to.

The present containers comprise a casing, for example, a coolant-insoluble and coolant-impermeable casing, having or defining a substantially hollow interior. The casing has at least one opening. The casing may have any suitable shape and size, which are often chosen to be compatible with the particular application involved. The casing, for example, may have a generally cylindrical shape, a generally bowl shape or any of a large number of other shapes. The casing may have one or more curved and/or planar walls or it can have all curved or planar walls.

The at least one opening in the casing may be provided at any location or locations in the casing. For example, such opening or openings can be located at the top and/or bottom and/or ends and/or side or sides of the casing, as desired. The choice of the location for the opening or openings often is at least partially based on the particular application involved, and/or the ease and/or the cost of manufacturing the present additive containers and the like factors and may have at least some effect on the performance effectiveness of the containers.

In order to illustrate and describe the invention more clearly, cylindrically-shaped casings and bowl-shaped casings are emphasized herein. However, the present invention is not limited thereto and is applicable to casings of other shapes. Containers including such other shaped casings are included within the scope of the present invention.

In one embodiment, the casing may be cylindrical in shape, for example, having a first end and a second end. The casing is provided with at least one opening, for example at one or both of the first end and second end and/or in the side wall of the casing. The casing may be substantially bowl-shaped. For example, the bowl-shaped casing defines a hollow interior, a top, bottom and one or more side walls. The opening or openings can be located in the top, bottom and/or one or more side walls.

A coolant additive composition, which comprises at least one coolant-soluble additive, is provided in the hollow interior of the casing. At least one coolant-permeable element is provided at or near at least one opening of the casing. For example, a coolant-permeable element advantageously is provided at or near each opening of the casing. Such coolant-permeable element or elements are effective to provide for release of a portion of the chemical additive composition into the coolant composition in contact with the casing, for example, in a sustained manner over time while retaining a balance of additive within the casing.

The casing of the container may be made of any suitable material or materials of construction. The casing as such has substantially no detrimental effect on the additive composition or the coolant composition or on the performance of the present container. The casing preferably is composed of a material selected from metals, such as steel, aluminum, metal alloys and the like, polymeric materials, combinations thereof and mixtures thereof. In one particularly useful embodiment, the casing is selected from metals, polyvinyl chloride (PVC), polyethylene (high density and/or low density), polypropylene (PP), nylon, polyethylene vinylacetate (EVA), polypropylene vinylacetate (PVA), polyester, acetal, polyphenylene sulfide (PPS), and the like, combinations thereof and mixtures thereof.

In one embodiment, the at least one coolant-permeable element or component of a present container, preferably comprising at least one coolant-permeable membrane, such as a porous or semi-permeable membrane, facilitates or permits contact of coolant composition with the chemical additive provided within the casing. The membrane may optionally be accompanied, when desired, by at least one membrane retention member or two or more retention members, for example, an open mesh screen, woven cloth and the like, effective in retaining the membrane in a substantially fixed position relative to, for example, within, the casing.

The coolant-permeable membrane of the invention is advantageously composed of a suitable coolant-insoluble material, preferably selected from polymeric materials, glasses, metals, combinations thereof and mixtures thereof. For example, suitable materials include, but are not limited to, glasses, nylon, cellulose acetate, polyester, polyethylene vinylacetate (EVA), polypropylene vinylacetate (PVA), polyvinyl chloride (PVC), cellulosic polymers, polyurethane, stainless steel mesh, sintered metal (such as sintered metal discs and the like), metal membrane filters (such as silver membrane filters and the like) and the like, as well as combinations thereof and mixtures thereof. The membrane can alternatively be a material through which a coolant additive can pass, for example, by diffusion (although not necessarily through pores), such as silicone rubber, polyethylene, polyvinylacetate, natural and synthetic rubbers, and other polymers and waxes, and combinations thereof and mixtures thereof. Such membranes are often referred to as semi-permeable membranes. In one embodiment, a “semi-permeable membrane” refers to a continuous film of a polymeric material permeable to coolant composition, which permits diffusion of molecules through microscopic channels. The pore size of such a semi-permeable membrane is not easily measured and is typically less than about 0.2 microns.

The coolant-permeable membrane of the present invention preferably comprises a porous membrane, advantageously a microporous membrane, such as those membranes having a pore size within the range of about 0.2 microns to about 300 microns. As referred to herein, a “membrane” may be a single layer or may include multiple plies. The thickness of the membrane is preferably in a range of about 0.1 mm to about 0.5 mm or about 1 mm or about 5 mm, although other thicknesses can be effectively employed. Examples of membrane materials include metal wire meshes; polymer, such as nylon and the like, meshes; filter media; combinations thereof and mixtures thereof and the like. Particularly useful membrane materials include materials useful as filter media, for example, in coolant filters. Examples of such materials include the filter medium sold by Fleetguard-Nelson under the trademark STRATOPORE and filter media available from Whatman and Millipore.

The coolant permeable membrane of the present apparatus comprises a suitable coolant-insoluble material, which can be a nylon, cellulose acetate, polyester, polyolefin, polyethylene vinyl acetate (EVA), polypropylene vinyl acetate (PVA), and the like, as well as combinations and mixtures thereof. In the event that a selected material is insufficiently rigid under the repeated hot-cold cycling of a cooling system, a more thermoresistant material, such as one made of ceramic, glass and the like, combinations thereof and mixtures thereof, can be employed.

As noted above, in one embodiment, the coolant-permeable element further comprises at least one retention member. For example, the membrane may be retained across the opening of the casing by one or more wire or mesh screens, for example, stainless steel mesh screens. The membrane may be sandwiched between at least two retention members. The retention members preferably are structured, for example, so as to have a mesh size, to facilitate or permit chemical additive from the casing to be passed, for example, by diffusion, into the coolant composition in contact with the container. For instance, the retainer member or members preferably have a mesh size in the range of about 10 to about 300 microns or about 500 microns or more. A particularly preferred retention member is metal, e.g., stainless steel screening and/or woven cloth.

One or more components of the coolant-permeable member may be at least partially soluble in the coolant composition in contact with the container. For example, the coolant permeable element may include an at least partially coolant dissolvable seal or sealing element, for example, a wax (paraffin) seal. The sealing element(s) can be applied to an assembled membrane(s) and/or retention member(s) to form a sealed container, which can be effectively shipped and/or stored without the additive composition leaking from the casing and/or being exposed to the atmosphere. In the event a liquid coolant additive composition is included in the casing, the seal(s) preferably are chosen so as not to be soluble in the liquid additive composition, for example, at or about ambient temperatures. This “additive-insoluble” seal feature substantially reduces or even eliminates the risk that the liquid additive composition will leak from the casing during shipment or storage. The seal(s) dissolve after the container or casing is exposed to coolant, for example, at elevated temperatures, thereby allowing the release of the chemical additive from the casing.

In a very useful embodiment, the sealing element or assembly is structured to delay the release of the coolant additive composition from the casing, even after the casing is placed in contact with the coolant. For example, the coolant may not require the additive or additives from the casing for a substantial period of time, particularly if a new coolant including a full complement of fresh additive is used in the cooling system. Thus, it may be advantageous to delay the release of the additives from the casing for a prolonged period of time.

In one embodiment, the sealing element includes a material which is resistant to dissolving in the coolant, for example, so that only after prolonged exposure to the coolant is the seal compromised and the additives from the casing released into the coolant. In a very useful embodiment, the material or materials used in the sealing element or assembly are selected to provide the desired degree or extent of delay in initiate release of the coolant additive composition into the coolant. Such selection can be easily determined, for example, by measuring the solubilities of various sealing materials in the coolant in question at the normal operating temperature and conditions of the specific application involved. Of course, the seal element or assembly can be structured so that the additive or additives from the casing are released into the coolant substantially immediately after the casing is contacted with the coolant.

In one particularly advantageous embodiment, the sealing element or assembly includes a support structure, for example, a porous material, such as a wire screen, a woven cloth material and the like, coated, impregnated or otherwise associated with a coolant soluble material or seal member, for example, wax, polymer and the like. For example, a preferred seal assembly comprises support structure, for example, a coolant-insoluble a support structure such as a wire screen, woven cloth and the like, that has been impregnated or coated or otherwise associated with a coolant-soluble material, for example, a coolant-soluble wax, polymer and the like, such as a molten coolant soluble polymer which is then allowed to cool and harden. Such a coolant soluble sealing material, for example, and the like, can be used as a sealing element without the support structure. In one embodiment, the support structure of the sealing element is a retention member for the membrane of the coolant-permeable element. The use of such a support structure/retention member is effective to facilitate sealing the container, for shipment and storage, and retaining the membrane in place during release of the additive from the casing.

In one particularly advantageous embodiment, the sealing element comprises a porous or microporous material, for example, a wire screen or a woven cloth material, coated or impregnated with a coolant soluble polymer. For example, a preferred seal comprises such a wire screen or woven cloth that has been impregnated with wax (insoluble) or polyvinyl alcohol, polyethylene oxide, including but not limited to or polyethylene glycol (soluble), and allowed to cool and harden.

Any suitable material or combinations of materials may be employed in the present at least partially coolant dissolvable seals, provided that such material or materials have no undue detrimental effect on the chemical additives, coolant compositions or the performance of the present containers. For example, the present seals may be selected from natural and/or synthetic waxes having a softening temperature of at least about 140 EF and which are soluble in the coolant composition to be treated. Representative materials from which the seals can be made include, without limitation, materials which are readily coolant soluble, such as polyethylene glycol, polyvinyl alcohol, polyethylene oxide and the like and combinations and mixture thereof; materials which are substantially resistant to dissolving in coolant, such as waxes, for example, polyethylene waxes, polypropylene waxes, and polyisobutylene waxes and the like and combinations thereof and mixtures thereof. Such materials do not harm coolant quality and may actually enhance coolant quality/performance.

The coolant additive composition provided within a container of the invention comprises at least one chemical additive effective when released into the coolant composition to confer or maintain one or more benefits or beneficial properties to the coolant composition and/or the coolant system in which the coolant composition is used. The additive composition may be provided in the form of a liquid, gel, paste or solid particles, for example, beads, tablets, pellets or grains, and the like, as well as mixtures thereof, within the casing. Such chemical additive preferably is selected from corrosion inhibitors, scale inhibitors, buffering agents, and the like, and can be a mixture thereof, as described more fully elsewhere herein.

A coolant additive composition of the invention can advantageously further comprise a coating material that at least partially surrounds or encapsulates or coats the chemical additive, as discussed elsewhere herein. Such coating material may be provided in order to at least assist in controlling, or to control, the release of chemical additive from the casing, as desired. The coating material may be either coolant-soluble or coolant insoluble. The coating on the chemical additive should be such as to allow or permit at least some release of the additives from the casing into the coolant composition.

The coolant additive components of the present invention may be located in a matrix material, for example, a coolant-insoluble matrix material, such as a coolant insoluble polymeric material. The matrix material, if any, should be such as to allow or permit release of the additive component from the casing into the coolant. The matrix material advantageously is effective to at least assist in controlling, or to control, the release of the additive component into the coolant. In one embodiment, the additive component is present in the casing and no matrix material is employed.

In one embodiment, as discussed herein, the coolant-permeable element or elements include a polymer-containing membrane, for example, a polymer-coated membrane, in order to achieve enhanced additive release control. In this latter aspect, the membrane, that is the membrane of the coolant-permeable element or elements, is suitably coated, impregnated or otherwise associated, for example, by spray coating, dip coating and the like, with a polymer material. Suitable polymer materials include without limitation, coolant insoluble materials which have no significant detrimental effect on the coolant composition being treated, on the additive components in the casing or on the performance of the present container. Examples of such coating materials include those listed by Mitchell et al U.S. Pat. No. 6,010,639, the disclosure of which is incorporated in its entirety herein by reference. A particularly preferred polymer material is polyethylene vinyl acetate copolymer. In addition, or alternatively, the present retention member(s) of the coolant-permeable element or elements can be coated, impregnated, or otherwise associated with a material, for example, a coolant-insoluble polymer material, such as those disclosed in Mitchell et al U.S. Pat. No. 6,010,639, to at least assist in controlling or to control, release of the additive composition from the casing, as desired.

The container of the present invention preferably is filled with one or more coolant additives through the opening or openings of the casing or otherwise.

The containers of the invention, for example, the casings of the containers, may include one or more coolant-impermeable cap members or coolant-impermeable plugs, which can be detachable or removable from the casing or the remainder of the casing, for example, to facilitate filling the interior space of the casing with additive composition.

In one embodiment of the present invention wherein the casing is substantially cylindrical shaped and the opening or openings are located at the end or ends of the casing, one or both ends of the casing may include a cap member, with at least one of the cap members being removable to allow the casing or cartridge to be filled or refilled with coolant additive composition. Another open end of the casing, if desired, may include a cap member that is permanently sealed thereto, for example, during manufacture, for example, during injection molding of the container. Whenever the cap or plug is attached by threading or screwing it onto the casing, screw threads can be applied to the respective pieces during or after molding with suitable dies or within the mold. The cap member can alternatively be applied to the casing by a press fit. In this case, suitable tolerances to make a snap fit between the casing and the end piece can be provided, for example, to the plastic injection molds used to make the respective pieces. The end piece can also be formed integrally with the casing, e.g., during injection molding.

The cap or end piece used to close at least one end of the casing containing the chemical additive typically is provided with at least one opening to permit release of chemical additive therethrough, and to provide fluid communication between the coolant composition located exterior to the container and the coolant additive composition disposed within the casing interior. Whenever an end piece is formed integrally with the casing, the opening can be provided therein during or after formation of the casing, for example, by injection molding.

It will be appreciated by those of skill in the art that release of additive composition into a coolant system utilizing a container of the present invention is provided, and the release rate may be substantially controlled by consideration of several factors. The following factors, as well as others, may also have an effect on the performance and effectiveness of the containers of the present invention. For example, a desired coolant additive release rate may be obtained by appropriate selection of: the number and type membrane layers; membrane composition; membrane pore size, if any; the presence, type and amount, if any, of polymer associated with, e.g., coated, on the support member or membrane and/or retention member; and the presence, type and amount, if any, of the coating on the additive composition. The rate of release may also be influenced by the number and size of openings in the casing and the like. Other factors to be considered include, among others, the type and form of chemical additive in the coolant additive composition, solubility of the additive, coolant temperature, and velocity of coolant through the coolant line and the like factors.

Further contemplated within the invention is a method for releasing a chemical additive, preferably at a controlled rate, into a liquid coolant composition. The method comprises placing in contact with the coolant composition a container or cartridge as described herein containing the chemical additive component or composition. The container or cartridge configuration described herein preferably permits a release, preferably a controlled release, of additive component from the casing interior into the coolant composition. It is contemplated that, in some configurations, coolant composition is permitted to flow around and encircle the casing containing the chemical additive. However, even in these configurations, release of chemical additive is preferably sustained and/or controlled, for example, by passive diffusion, rather than by forced flow of coolant composition through the casing.

A chemical additive component for use in a container or cartridge of the invention preferably is provided as a liquid, gel, paste or as particles, for example, beads, tablets, pellets, grains, coated versions of these, and the like, as well as mixtures thereof. The particles have a physical size large enough to prevent passage through the coolant-permeable components of the invention as described elsewhere herein.

A chemical coolant additive for use with the present invention is such as to be effective to serve some beneficial function within the coolant composition and/or cooling system. For instance, the coolant additive composition can include one or more of an anti-fouling agent, a pH buffering agent, a surface pitting inhibitor, a metal corrosion or hot surface corrosion inhibitor, a defoaming agent, a scale inhibitor, a hot surface deposition inhibitor, a dispersing agent, a surfactant, and the like, and mixtures thereof. One very useful coolant additive composition is a combination of ammonium or alkali metal salts of nitrite, nitrate and molybdate ions, particularly a combination of sodium nitrite, sodium nitrate, and sodium molybdate. Additional additives include, for instance, ammonium or alkali metal salts, for example, phosphate salts, borate salts, silicate salts, acidic salts, basic salts and the like and mixtures thereof. Further additives that can be used with the present invention are found in Mitchell et al U.S. Pat. No. 6,010,639, the disclosure of which is incorporated herein in its entirety by reference.

In one embodiment, the additive component comprises one or more of the following: (1) buffers to maintain the desired degree of acidity/alkalinity, e.g., a neutral or alkaline pH, including for example, alkali metal phosphates, borates and the like and mixtures thereof; (2) cavitation liner pitting inhibitors including alkali metal nitrites, molybdates and the like and mixtures thereof; (3) metal corrosion inhibitors and/or hot surface corrosion inhibitors including alkali metal nitrates and silicates, carboxylic acids, phosphonic acids, phosphonates, pyrophosphates, azoles, sulfonic acids, mercaptobenzothiazoles, metal dithiophosphates, metal dithiocarbonates, phenolic anti-oxidants including 4,4′-methylenebis (2,6-di-tertbutylphenol that is commercially available under the trademark Ethyl 702 by Ethyl Corporation) and the like and mixtures thereof; (4) defoaming agents including silicone defoamers, alcohols such as polyethoxylated glycol, polypropoxylated glycol, acetylenic glycols and the like and mixtures thereof; (5) hot surface deposition inhibitors and/or scale inhibitors including phosphate esters, phosphino carboxylic acids, polyacrylates, styrene-maleic anhydride copolymers, sulfonates and the like and mixtures thereof; (6) dispersants including non-ionic and/or anionic surfactants, e.g., phosphate esters, alkyl sulfonates, aryl sulfonates, alkylaryl sulfonates, linear alkyl benzene sulfonates, alkylphenols, ethoxylated alcohols and carboxylic esters, and the like and mixtures thereof; (7) organic acids including adipic acid, sebacic acid and the like and mixtures thereof; (8) anti-gel agents including those disclosed in Feldman et al U.S. Pat. No. 5,094,666, the disclosure of which is incorporated in its entirety herein by reference, copolymers of ethylene and vinyl esters of fatty acids with molecular weights of 500-50,000, tallow amine salts of phthalic anhydride, tallow amine salts of dithiobenzoic acid, 4-hydroxy,3,5-di-t-butyl dithiobenzoic acid, ethylene vinylacetate copolymers and the like and mixtures thereof; and (9) microbiocides, preferably microbiocides used in cooling towers, including those disclosed in Sherbondy et al U.S. Pat. No. 5,662,803, the disclosure of which is incorporated in its entirety herein by reference, and the like and mixtures thereof.

The additive components useful in the present invention may include one or more of the agents listed in the following Table 1. The possible functions of the agents identified in Table 1 are only intended to be exemplary, not limiting.

TABLE 1

| | | TYPICAL |
|---|---|---|
| | | % BY WT. |
| | | IN ADDITIVE |
| COMPONENT | POSSIBLE FUNCTION | COMPONENTS |
| Alkali metal or | corrosion inhibitor/ | 0-80 |
| Ammonium phosphates | buffering agent | |
| Alkali metal or | corrosion inhibitor/ | 0-80 |
| ammonium phosphonate | buffering agent | |
| Alkali metal or | corrosion inhibitor/ | 0-80 |
| ammonium pyrophosphate | buffering agent | |
| Alkali metal or | corrosion inhibitor/ | 0-80 |
| ammonium borate | buffering agent | |
| Alkali metal or | cavitation liner | 4-60 |
| ammonium nitrites | pitting/corrosion inhibitor | |
| Alkali metal or | cavitation liner | 4-60 |
| ammonium molybdates | pitting/corrosion inhibitor | |
| Alkali metal or | corrosion inhibitor | 4-60 |
| ammonium nitrates | | |
| Alkali metal or | corrosion inhibitor | 0-40 |
| ammonium silicates | | |
| Alkali metal or | corrosion inhibitor | 1-15 |
| ammonium salts of one | | |
| or more neutralized | | |
| dicarboxylic acids | | |
| Tolyltriazole | corrosion inhibitor | 1-15 |
| Dispersants (e.g. | deposition and scale | 0-15 |
| polyacrylic acid, | inhibitors | |
| phosphino carboxylic | | |
| acid, phosphate esters, | | |
| styrene-maleic anhydride | | |
| copolymers, polmaleic acid, | | |
| sulfonates and sulfonate | | |
| copolymers) | | |
| Defoamers (e.g. silicones, | foam inhibitor | 0-3 |
| polyethoxylated glycol, | | |
| polypropoxylated glycol, | | |
| acteylenic glycols) | | |

In one embodiment, the additive component includes nitrite compounds. The additive component may include a mixture of nitrite compounds and molybdate compounds to maintain a minimum concentration level of about 800 ppm of nitrite or of nitrite and molybdate in the coolant in the cooling system, with the proviso that the minimum level of nitrite in the coolant system is often about 400 ppm. A useful additive providing nitrite compounds is sold by Fleetguard under the trademark DCA-2 Plus, which includes borate, silicate, organic acids, tolytriazole, scale inhibitors, surfactants and defoamers, in addition to nitrite and molybdate.

In another embodiment of the present invention, the additive component includes a mixture of nitrite, nitrate and molybdate compounds. A useful additive component comprises nitrite, nitrate, phosphate, silicate, borate, molybdate, tolyltriazole, organic acid, scale inhibitor, surfactant and defoamer. Such an additive is sold by Fleetguard under the trademark DCA-4 Plus.

A solid coolant additive composition of the present invention is shaped and sized in a manner that facilitates its handling, and conveniently is molded in the form of a pellet or tablet having a spherical or irregular shape. It is large enough to avoid passing through porous components used to retain the additive composition in the casing of the container. Such tablets or pellets can begin to break apart within minutes of exposure to coolant, however, the fragmented particles are retained by the porous component, with dissolution occurring inside the vessel. A concentrated solution of chemical additive is thereby formed within the container, which is permitted to pass, e.g., diffuse through the membrane as desired for combining with the coolant composition. The rate of diffusion is controlled by such parameters as flow rate and temperature of the coolant composition, pore size, orifice diameter, the presence or absence of a coating material on the porous membrane, the inclusion of a plug between the membrane and additive material to further restrict release, additive solubility and the presence or absence of a coating material thereon, and the like. Each dimension of length, width and thickness of the particle should be in the range from about 1/32 inch to about 3 inch. Suitable binders may be used, as known in the art, and include water-soluble acrylates, cellulosics, polyglycols, and silicates. The coolant additive composition may include one or more additional materials used, for example, to strengthen, stabilize and/or otherwise enhance the composition.

A coating material may be provided in an amount effective to at least partially encapsulate and/or coat and/or bind the coolant additive composition, thereby restricting the release of additive composition into the coolant composition. A coating material preferably has no or limited water solubility so that dissolution and/or diffusion of the additive composition into the coolant is further controlled. Thus, such coating acts to provide an additional degree of control over the release of the additive to the coolant composition.

Suitable coating materials include film-forming polymers, such as (meth)acrylates and vinyl chloride-based polymers and copolymers, as well as water-based emulsion polymers, such as polymers and copolymers of vinyl versatates and ethylenically unsaturated monomers. Exemplary coating materials for such use are listed in Mitchell et al U.S. Pat. No. 6,010,639. Generally, a preferred coating material is a polymer composition selected by the skilled practitioner on the basis of one or more of its viscosity, its film forming temperature, its glass transition temperature, its physical adherence to the substrate, its degree of solubility in coolant composition and its stability in coolant composition under operating temperatures, for example.

In a preferred embodiment, an aforementioned coating material can also be used to coat an aforementioned membrane of the invention. In a particularly preferred embodiment, the membrane is coated with a polyvinyl acetate (PVA) emulsion. Moreover, a preferred release rate for chemical additive through the membrane can be provided by adjusting the coating thickness to produce the preferred release rate. Suitable film forming polymers include, for example, homopolymers, copolymers, and mixtures thereof, wherein the monomer units of the polymers are preferably derived from ethylenically unsaturated monomers or cellulose derivatives.

A coating material is applied to the membrane by any suitable method. Preferred methods include dipping, spray coating, and drum or pan coating. In a preferred embodiment, a coating material is spray-coated onto the membrane in an amount ranging from about 1% to about 95% by weight of the membrane.

A device of the present invention can be placed in a coolant filter, either upstream or downstream of the filter medium, or it can be provided in a substantially fixed position in the coolant line, either upstream or downstream of a coolant filter. Release of an additive into the coolant is governed, at least in part, by pore size, membrane thickness, membrane composition, surface area of the membrane, viscosity of liquid additive, surface tension and membrane wetting ability of the additive, operating temperature and the like.

The invention will now be described with reference to certain examples, which illustrate but do not limit it.

### EXAMPLES

### Example 1

### Dual Release Vessel

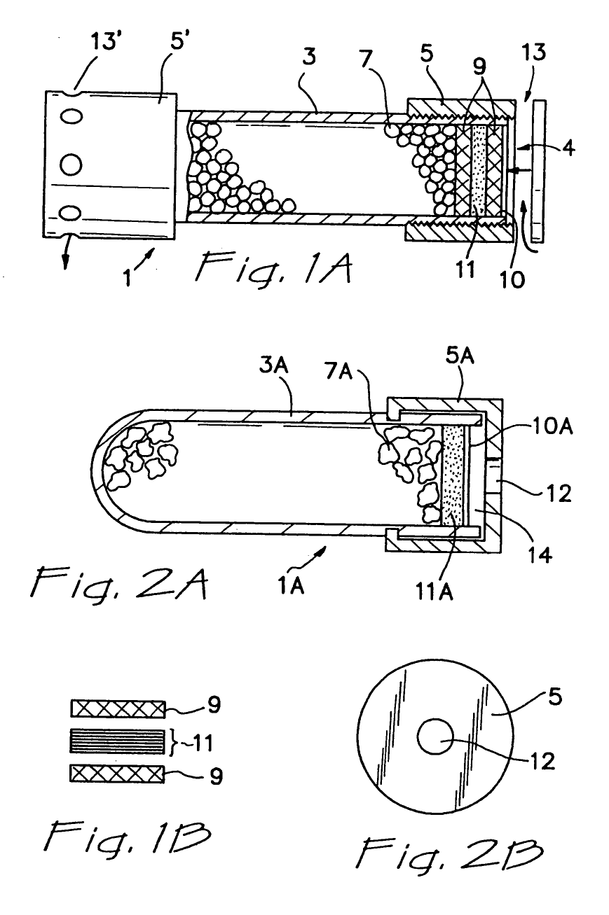

Referring now to FIG. 1A, container 1 comprises a solid, open ended, cylindrically shaped PVC casing 3 and end caps 5 and 5′, which are screwed onto the casing. The casing 3 has two open ends 4. Provided within the casing are particles 7 of a coolant additive composition, which is retained within the casing by inner and outer screens 9 and coolant-permeable membrane 11. Wax seal 10 is applied to outer screen 9 for shipment/storage of the container. Alternately, or in addition, the wax seal can be applied to inner screen 9. If the seal is located on the top, the seal will come in contact with the coolant substantially immediately and effect a faster release of the coolant additive composition. If the seal is located on the bottom, the coolant must first pass through the membrane in order to dissolve the wax. Such placement of the seal can be useful to delay the initial release of coolant additive composition, if such delay is desired. The wax seal dissolves whenever the container is placed in use. End caps 5 and 5′ are provided with openings 13 and 13′, respectively, which permit infiltration of coolant composition and contact with the porous membrane 11 in the casing 3. Moreover, release of coolant additive through the membrane 11 permits its incorporation into the coolant composition and its circulation throughout the coolant system. The arrows in FIG. 1A show the flow of coolant composition in and around the container 1.

FIG. 1B is an exploded view of a preferred coolant-permeable element of the invention, which comprises mesh screens 9 on either side of coolant-permeable membrane 11. The screens 9 are sized and effective to hold membrane 11 in position in casing 3. Coolant-permeable member 11 is effective to allow coolant composition to contact particles 7 and to permit coolant additive to exit casing 3. The screens further assist membrane 11 to retain particles 7 within the casing 3.

For a container 1, six (6) inches in length having a 1.5 inch inner diameter, the amount of additive inside the casing is about 186 mL (173 g). Paraffin (wax) seal 10 may be applied to outer screen 9. A preferred wax has a melting point of 158° and dissolves in coolant over several hours at 100°. Release of effective amounts of additive starts in less than about 24 hours.

### Example 2

### Single Release Vessel

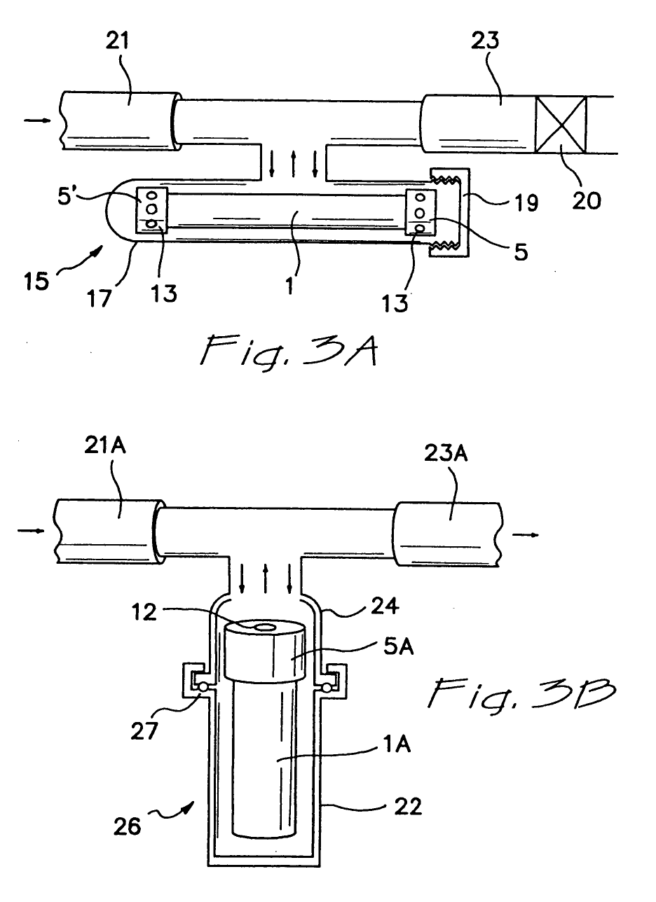

FIG. 2A depicts a cross-sectional view of an alternative embodiment of the present container, shown as 1A. In this embodiment, casing 3A is structured similarly to casing 3, but has only a single open end 14, which is capped with end cap 5A. The end cap 5A is press-fit onto casing 3A, rather than being screwed on, and is further provided with release orifice 12 that at least assists in controlling release of additive from the container 1. In this embodiment, membrane 1A is sufficiently rigid to hold it in place and retain particles 7A. Wax seal 10A is located in proximity to, preferably on, membrane 11A to seal container 1A for shipment/storage. FIG. 2B shows an end view of the end cap 5A shown in FIG. 2A, clearly showing orifice 12. Container 1A is effective, when placed in contact with coolant composition, to release additive composition from casing 3A into the coolant in a sustained manner over a period of time.

### Example 3

### Dual Release Configuration

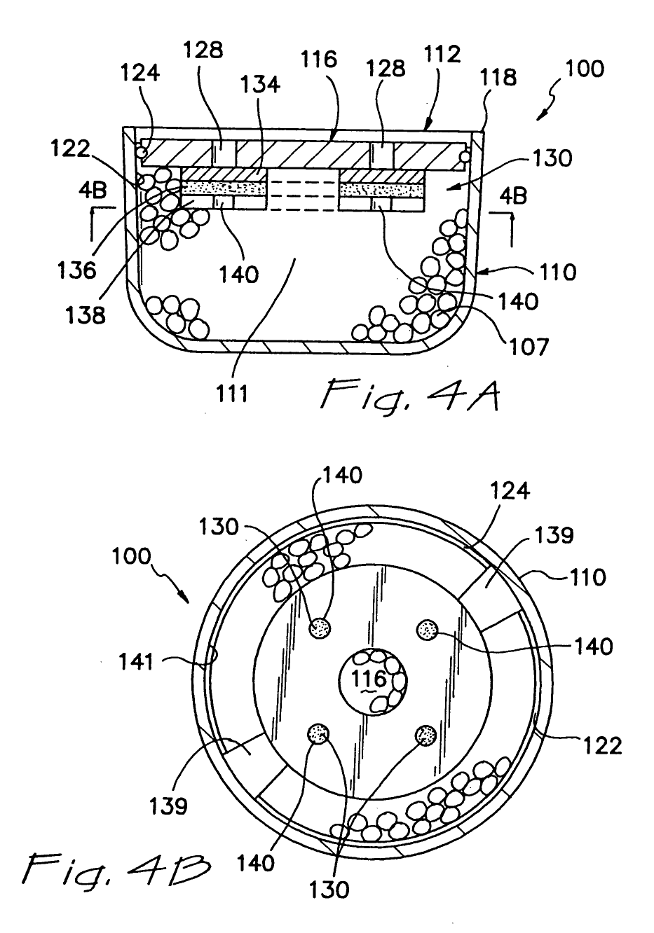

FIG. 3A illustrates one aspect of the present invention in which a dual-release container 1A (as shown in FIG. 1A) is employed in a “bypass” additive release vessel. In particular, container 1A lies horizontally in housing 15 and is held therein by screw cap 19, which is secured to housing body 17. Coolant flow from inlet line 21 enters housing 15 and exits via exit line 23. While inside the housing 15, coolant circulates through openings 13 and 13′ in end caps 5 and 5′, respectively, causing the release of additive from container 1A into the coolant. Generally, coolant flows into the housing 15 by the action of a coolant pump (not shown) of the coolant system, it being understood that gravity may also play a role. In addition, a coolant filter element 20, for example, of conventional and well known design, is located in exit or outlet line 23. It is understood that filter element 20 could alternatively be located in inlet line 21. Such alternative is included within the scope of the present invention.

### Example 4

### Single Release Configuration

As shown in FIG. 3B, a further aspect of the invention has container 1A (as shown in FIG. 2A) positioned in a vertical alignment within housing 26 provided in a “bypass” configuration with the coolant system. Representative diameter for the orifice 12 is 0.75 inch for a container 1A that is 6 inches in length and has a 1.5 inch inner diameter. As shown, housing body 22 and housing top 24 interlock to secure the container within the housing 26. A housing O-ring seal 27 is provided between housing body 22 and housing top 24 to seal the interior space of housing 26. Coolant flow from inlet line 21A enters housing 26 and exits via exit line 23A. While inside housing 26, coolant passes in and out of orifice 12 causing the release of additive from the container 1A into the coolant. A coolant pump and a coolant filter element may be employed by this embodiment in a manner analogous to that described in Example 2.

### Example 5

### Bowl-Shaped Configuration

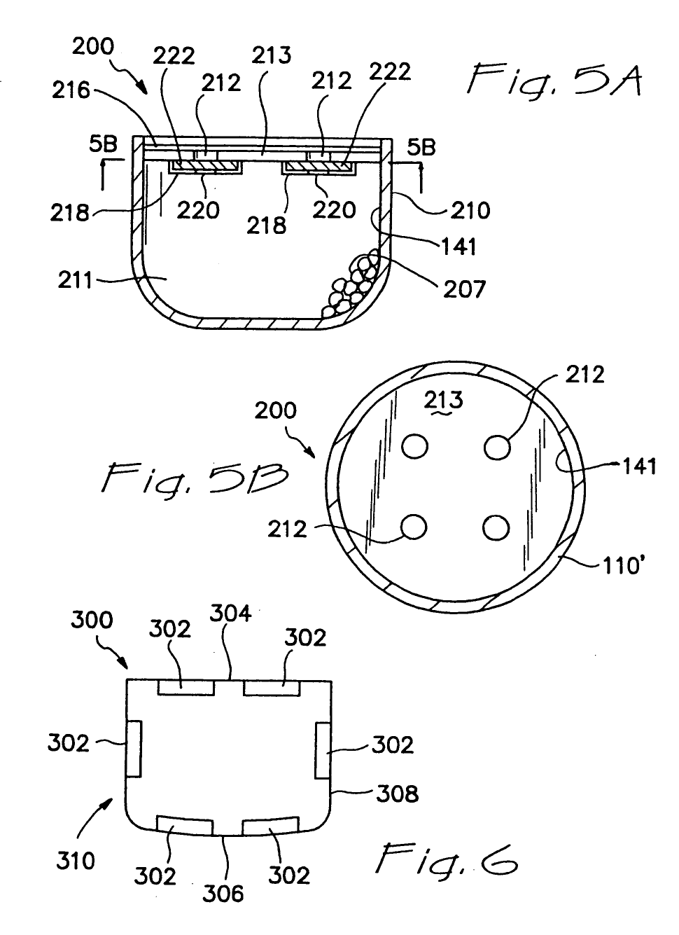

Turning now to FIGS. 4A and 4B, an additional container 100 of the present invention is shown. The container 100 generally comprises a bowl-shaped, coolant-impermeable casing 110 having an interior 111 filled with a coolant additive composition 107, and a relatively wide open top end 112 which is, for example, circular in shape. The container 100 further comprises a cap member 116 disposed across, and preferably substantially completely covering the open end 112.

The container 100 is useful in a coolant line, for example, of an internal combustion engine (not shown). The container is typically placed or secured in the coolant line, for example, in a manner analogous to that shown in FIGS. 3A and 3B.

Preferably, in the preferred container 100 shown, the cap member 116 is removably secured to the casing 110 in order to allow for filling and/or refilling of the container 100 with coolant additive composition 7. As shown, the cap member 116 may be recessed from a periphery, or rim 118, of the casing 110.

The cap member 116 may be secured to an interior surface 122 of the casing 110 by means of a resilient o-ring 124 or the like.

The cap member 116 includes at least one inlet 12B, preferably a plurality of inlets 128, to allow a liquid coolant composition (not shown) flowing exterior to the container 100 to enter the casing 110 and contact the coolant additive composition 107.

A coolant-permeable element 130 is provided for controlling release of coolant additive into the coolant. More specifically, the coolant permeable element includes a dissolvable seal layer 134, a membrane filter member layer 136 and a plate member 138 having one or more inlets 140 therethrough.

The dissolvable seal layer 134 preferably comprises a wire or mesh screen, for example a stainless steel screen, impregnated with a coolant-soluble polymer as described elsewhere herein. The layer 136 is a layer of filter medium, as described elsewhere herein.

The plate member 138 may be made of aluminum or other material or materials that are insoluble in aqueous-based coolant. The plate member 138 is second in place in interior 111 using internally extending tabs 139 which are in fixed, abutting relation to the inner wall 141 of casing 110. As shown in FIG. 4A, the plate member inlets 140 generally align with the cap member inlets 128. Alternatively, the plate inlets 128 and the cap inlets 140 may be partially or entirely offset from one another. It will be appreciated that the size (and offset position if applicable) of the inlets 128, 140 will generally affect the rate of release of coolant additive into the coolant. In the shown embodiment, each of the seal layer 134, membrane layer 136 and plate member 138 are annular, or “donut” shaped.

As shown in FIG. 4A, the dissolvable seal layer 134 overlays the membrane layer 136, and both of these layers 134, 136 are sandwiched between the cap member 116 and the plate member 138. The seal layer 134 and the filter media layer 136 may alternatively comprise smaller, multiple elements that are sufficiently sized to at least shield the inlets 128, 140.

Container 100 functions in a manner substantially analogous to container 1A, and is effective to release additive from the container into the coolant. A coolant pump and a coolant filter element may be employed in this embodiment in a manner analogous to that described in Example 2.

### Example 6

### Alternative Bowl-Shaped Configuration

FIGS. 5A and 5B show still another container 200 of the present invention that is generally similar to the container 100 shown in FIGS. 4A and 4B. The container 200 generally comprises the bowl-shaped casing 210 defining a hollow interior 211 for containing coolant additive composition 207. In addition, an aluminum plate member 213 is secured to the inner wall 241 of casing 210 for retaining the coolant additive composition 207 within the casing 210. The aluminum plate member 213, including a plurality of inlets 212, for example, four inlets 212 as shown. Covering each of the plurality of inlets 212 is a dissolvable, coolant-soluble polymer seal 216.

Four individual support structures 218 are secured to plate member 213 directly below each of the inlets 212. Each of these structures 218 has an opening 220 and is sized to accommodate a membrane segment 222 between the plate member 213 and the opening 220.

Container 220 can be used in a manner analogous to container 100 and functions and is effective to release additive from the interior into the coolant. A coolant pump and a coolant filter element may be employed in this embodiment in a manner analogous to that described in Example 2.

### Examples 7 and 8

### Containers Including Differently Placed Openings

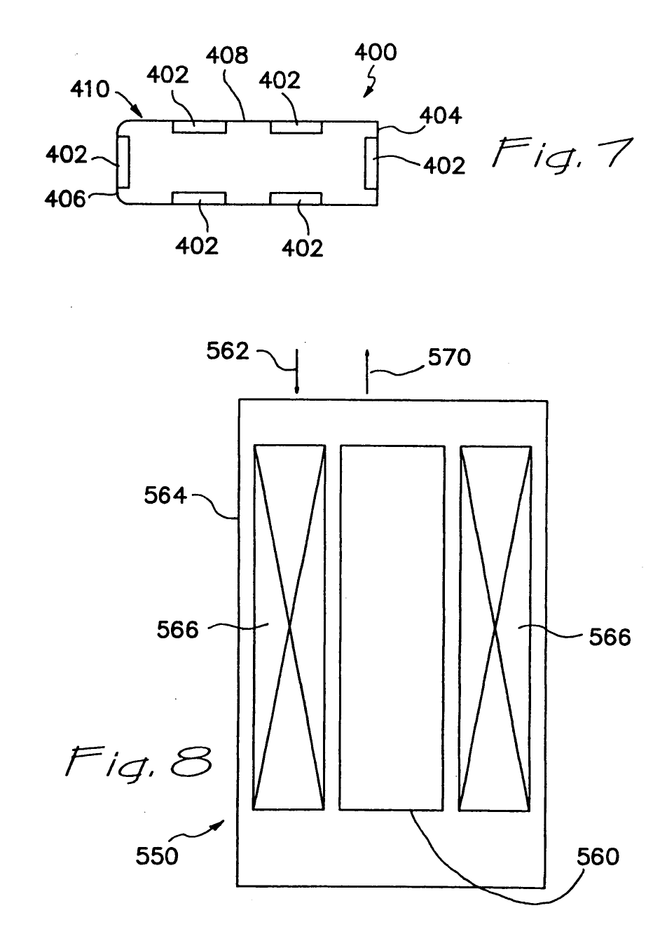

As noted elsewhere herein, containers which include openings and coolant-permeable elements at any location or locations on the casing of the containers are included within the scope of the present invention. For example, as shown in FIG. 6, a bowl-shaped container 300 can have one or more structures which include at least one opening and a coolant-permeable element, which structures are shown generally as 302, in the top 304 and/or bottom 306 and/or side wall 308 of the casing 310. Also, as shown in FIG. 7, a cylindrical shaped container 400 can have one or more structures which include at least one opening and a coolant-permeable element, which structures are shown generally as 402, in the first end 404 and/or second end 406 and/or side wall 408 of the casing 410.

Each of the structures 302 and 402 include an opening in the casing 310 and 410, respectively; a seal layer, effective for shipment/storage; and a membrane layer effective in controlling the release of the additive in the casing into the coolant. The structure or structure 302 and 402 are secured to the casings 310 and 410, respectively, using techniques analogous to those described herein to secure coolant-permeable elements to casings. Such analogous techniques are well within the ordinary skill in the art and need not be described in detail here.

Containers 300 and 400 can be used in manners analogous to those described herein with respect to containers 1, 1A, 100 and 200, and are effective to release additive from the container into the coolant. A coolant pump and a coolant filter element may be employed in this embodiment in a manner analogous to that described in Example 2.

### Example 9

### Filer Assemblies Including Additive Containers

FIG. 8 schematically illustrates a coolant fluid filter assembly 550 in which an additive container 560 in accordance with the present invention is employed is the center tube. The container 560 is cylindrically shaped and is configured generally analogously to many of the containers described elsewhere herein.

Coolant fluid from inlet line 562 passes into filter housing 564 and comes into contact with filter medium 566, of conventional structure. The filtered coolant fluid is then contacted with container 560 and additive from the container is released into the coolant fluid. The filtered, additive enriched coolant fluid then passes from the filter housing 554 through outlet line 570 and ready for use in coolant system service.

It should be noted that the filter assembly can be configured so that the coolant fluid contacts the additive container first before contacting the filter medium, and such alternate configuration is within the scope of the present invention.

In any event, the additive container 550 acts and is effective both to provide for sustained release of additive and as a structural member for the filter assembly 550.

While the present invention has been described with respect of various specific examples and embodiments, it is to be understood that the invention is not limited thereto and that it can be variously practiced within the scope of the following claims.

What is claimed is:

1. A method for treating a liquid coolant composition used in a cooling system, the method comprising:
placing a container separate and apart from a filter housing in contact with a liquid coolant composition used in a cooling system, the container comprising a liquid coolant composition-impermeable casing defining a substantially hollow interior and at least one opening;
a coolant additive composition provided in the interior of said casing, said coolant additive composition comprising a chemical additive soluble in the liquid coolant composition; and
at least one liquid coolant composition-permeable element provided at or near the opening of the casing and effective to provide for release of a portion of the coolant additive composition into the liquid coolant composition in contact with the casing, thereby treating the liquid coolant composition.

2. The method of claim 1 wherein the cooling system is an open circulating cooling system.

3. The method of claim 1 wherein the open circulating cooling system is a cooling tower.

4. The method of claim 1 wherein the liquid coolant composition comprises liquid water.

5. The method of claim 1 wherein the casing is composed of a material selected from the group consisting of metals, polymeric materials, combinations thereof and mixtures thereof.

6. The method of claim 1 wherein the casing is a substantially cylindrical-shaped casing.

7. The method of claim 6 wherein the at least one opening comprises at least one open end of the cylindrical-shaped casing or at least one side opening in a sidewall of the cylindrical-shaped casing.

8. The method of claim 1 wherein the casing is a substantially bowl-shaped casing.

9. The method of claim 8 further comprising a cap member disposed across a top of the substantially bowl-shaped casing.

10. The method of claim 8 wherein the at least one opening is located in a top of the substantially bowl-shaped casing, in a side of the substantially bowl-shaped casing or in a bottom of the substantially bowl-shaped casing.

11. The method of claim 1 wherein the at least one liquid coolant composition-permeable element comprises an at least partially liquid coolant composition soluble seal.

12. The method of claim 11 wherein the at least partially liquid coolant composition soluble seal comprises a support structure coated with a liquid coolant composition soluble polymer.

13. The method of claim 12 wherein the support structure comprises a wire screen, a woven cloth or combinations thereof.

14. The method of claim 1 wherein the at least one liquid coolant composition-permeable element includes a porous membrane.

15. The method of claim 14 wherein the at least one liquid coolant composition-permeable element includes at least one retention member effective in retaining the membrane in a substantially fixed position relative to the casing.

16. The method of claim 14 wherein the porous membrane comprises a material selected from the group consisting of metals, glasses, polymeric materials, papers, combinations thereof and mixtures thereof.

17. The method of claim 1 wherein the at least one opening comprises a plurality of openings and the at least one liquid coolant composition-permeable element comprises a corresponding plurality of cooling water-permeable elements.

18. The method of claim 1 wherein the coolant additive composition is provided in a particulate form or in a liquid form.

19. The method of claim 1 wherein the coolant additive composition includes an additive is selected from the group consisting of corrosion inhibitors, microbicides, scale inhibitors, dispersants, buffering agents, surfactants, anti-fouling agents and mixtures thereof.

20. The container of claim 1 wherein the at least one liquid coolant composition-permeable element is at least partially coated with a polymeric coating material.
